(19) United States
(12) Patent Application Publication
(10) Pub. No.: US 2007/0261737 A1
(43) Pub. Date: Nov. 15, 2007

(54) Modular Unit

(75) Inventors: Artur Jung, Quierschied (DE); Norbert Sann, Riegelsberg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: HYDAC FILTERTECHNIK GMBH, Sulzbach/Saar (DE)

(21) Appl. No.: 11/629,752

(22) PCT Filed: Apr. 26, 2005
(86) PCT No.: PCT/EP05/04442

§ 371 Date: May 18, 2007

(30) Foreign Application Priority Data
Jun. 17, 2004 (DE) 10 2004 040 909.9

(51) Int. Cl. F15B 21/04

(52) U.S. Cl. 137/334; 137/565.17

(57) ABSTRACT

The invention relates to a modular unit, comprising at least one filter (10), pump (12) and cooling (14) unit which are fluidically connected to each other by means of a connection module (16) and which can be connected to a tank unit (18). By virtue of the fact that the connection module (16) opens out inside (22) the tank unit with a suction opening (20), together with the cooling unit (14) when the tank unit is connected (18) and the fact that the filter unit (10) and pump unit (12) are arranged outside the tank unit (18), it is possible to place the modular unit on a tank unit and connect it thereto. The cooling unit protrudes inside the tank unit.

The invention relates to a modular unit consisting of at least one filter unit, one pump unit and one cooling unit, which can be connected to each other to carry fluid by way of a connecting module and which can be connected to a tank unit.

WO 98/42986 A1 discloses a fluid cooling device as a modular unit with a motor which drives a fan wheel and a fluid pump which takes fluid from an oil tank and delivers it to a hydraulic working circuit which heats the fluid, and routes it to a heat exchanger (cooling unit) from which the fluid, cooled, is returned to the oil tank, the oil tank being made trough-shaped and with raised trough edges partially encompassing at least the motor and the fluid pump in the shape of a half shell. With the known solution, it is possible to connect the actual modular unit consisting of a filter unit, a pump unit and a cooling unit in a space-saving manner to a relatively high-volume oil tank as the tank unit, proceeding from the installation space left free by the trough edges of the oil tank good accessibility of the remaining modular unit being ensured for mounting and maintenance purposes. The known fluid cooling device for the most part avoids additional tubing; this on the one hand helps save costs and on the other hand this structure is energy-efficient, because in this way losses in the fluid lines are avoided. Regardless however, it is fundamental such that the known fluid cooling device can be sold only as an integral modular unit consisting of the combination of filter unit, pump unit, cooling unit and tank unit, and in particular retrofitting onto existing oil tanks or tank units with the further modular unit is hardly possible. Since these tank units and oil tank units often originate from other manufacturers and are already on site, depending on the respective application it would however be desirable to retrofit these units with a modular unit consisting of a filter unit, a pump unit and a cooling unit as required, or if necessary to undertake modifications such that one fluid cooling device is replaced by a new one, for example with greater capacity, and in this connection the respective tank unit remains on site.

Accordingly, the prior art (WO 01/18363 A1) discloses connecting fluid cooling devices as a modular unit to oil tanks or tank units provided separately from them. Thus the known solution relates to a fluid cooling device with a cooling means, filter means, and pump means combined into a modular unit, the fluid conveyed in the fluid circuit by the pump means being filterable by the filter means and coolable by the cooling means and the filter means having at least one filter element which can be replaced when it is fouled. In that in the known solution for the replacement of the respective filter element in the fluid circuit an actuatable blocking means is present with which the filter means can be separated from the pump means such that the cooling means is further supplied with the fluid to be cooled, it is possible in the known solution to enable the indicated filter element replacement without additional effort even if the downstream lubricating oil supply is not shut off. The known fluid cooling device can be connected as a modular unit, depending on its capacity, to any oil tanks or tank units, for this purpose however the corresponding tubing, or fluid-carrying lines, between the modular unit and the tank unit being necessary. As already explained, this is associated with the corresponding complexity in terms of production and installation; this raises costs and furthermore flow resistances arise due to the length of the fluid lines provided between the modular unit and the tank unit; this has adverse effects on the energy-efficient operation of the means as a whole. The additional fluid lines also result in increased installation space; in applications in automotive and mechanical engineering and apparatus engineering this often leads to problems, where often there is only little installation space due to given boundary conditions.

On the basis of this prior art, therefore the object of the invention is, while retaining the advantages of the known solutions, to further improve them such that the modular units under consideration are compact, can be retrofitted onto existing tank units and are interchangeable, and permit energy-efficient operation and economical implementation.

This object is achieved by a modular unit with the features of claim 1 in its entirety.

In that, as specified in the characterizing part of claim 1, the connecting module, with the tank unit connected, with an intake opening together with the cooling unit discharges into the interior of the tank unit and in that the filter unit and pump unit are located outside the tank unit, the modular unit can be placed on the tank unit, for example in the form of an oil tank, and can be connected to it, the cooling unit projecting into the interior of the tank unit. Accordingly the intake opening likewise projects into the interior of the tank and in this way enables continuing removal of the fluid stored in the tank unit by way of the pump unit. The other units (filter unit and pump unit) are located easily accessibly outside the tank unit, and piping in the form of fluid lines between the modular unit and the tank unit can be avoided by direct placement and engagement of the modular unit on or with the tank unit. The modular unit is preferably located on a side wall of the tank unit.

By removal via the intake opening within the tank unit the free fluid paths are clearly reduced compared to known solutions; this benefits energy-efficient operation of the overall modular unit. Furthermore the design as claimed in the invention is compact and can be easily replaced by a new modular unit, for example one with greater performance capacity, if this should be necessary. Energy-efficient operation of the overall modular unit is also benefited by the fact that the cooling unit discharges into the interior of the medium of the tank unit to be cooled, so that the medium cooled directly via the cooling unit can be further routed on to the tank unit. In this way, a uniform temperature situation also arises within the tank unit; this enables defined fluid removal by way of the pump unit.

In one preferred embodiment of the modular unit as claimed in the invention, at least two, preferably three units running at a right angle to one another are connected to the connecting module. But preferably the connecting module consists of an angular housing with two connecting arms running at a right angle to one another and furthermore has at least one additionally arranged flange part. In this way, the individual units of the modular unit can be arranged relative to one another in the form of a T-module or in the manner of a Cartesian coordinate system; this in turn helps shorten the free fluid paths within the connecting module and furthermore also helps save installation space on the tank unit. Based on the configuration of the connecting module with connecting arms and a flange part, moreover in special cases other connection possibilities for other components can be devised, for example in the form of a second filter element or the like.

Other advantageous embodiments of the modular unit as claimed in the invention are the subject matter of the other dependent claims.

The modular unit as claimed in the invention will be detailed below using one embodiment as shown in the drawings. The drawings are schematic and not so scale.

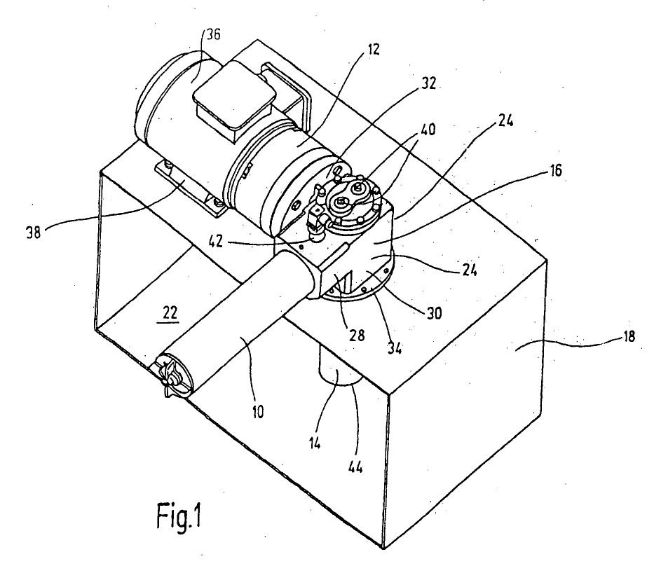

FIG. 1 shows in a perspective view the modular unit connected to a tank unit:

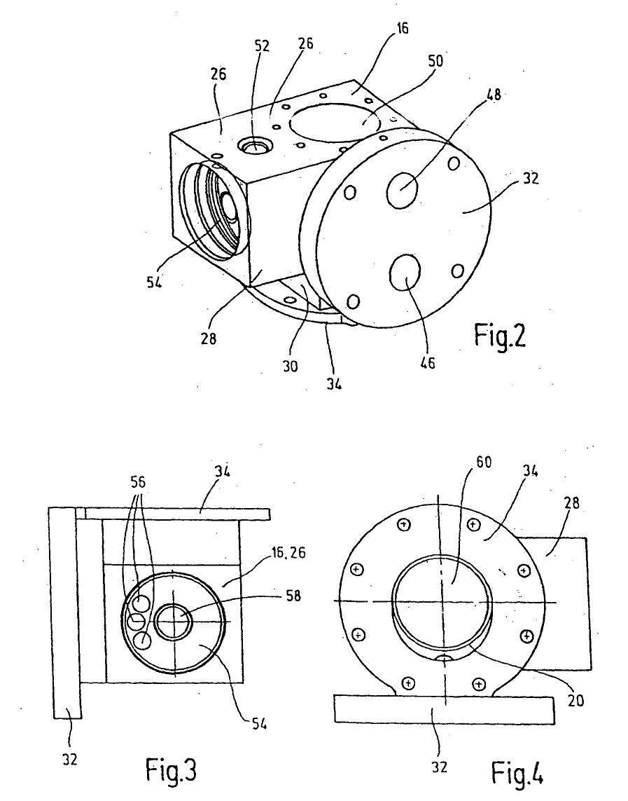

FIGS. 2 to 5 show in different views the connecting module of the modular unit;

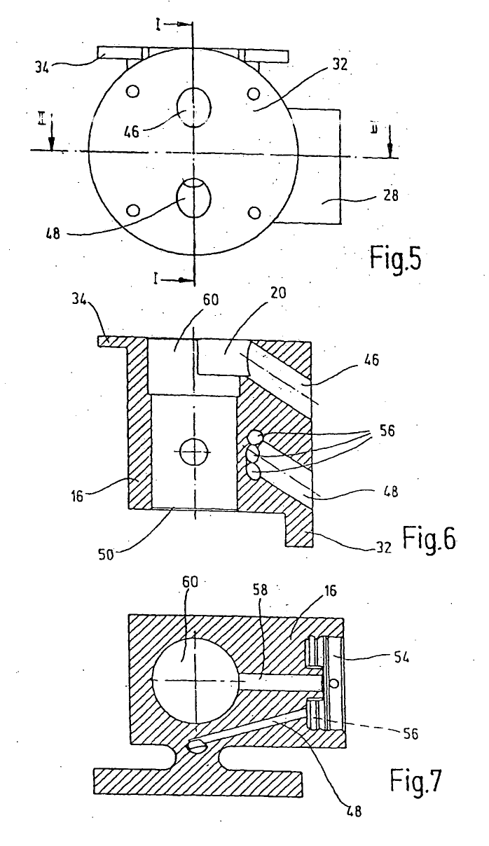

FIGS. 6 and 7 show a section along lines I-I and II-II in FIG. 5.

The modular unit shown as a whole in FIG. 1 has a filter unit 10, a pump unit 12 and a cooling unit 14 (shown only partially). These units can be connected to one another to carry fluid by way of a connecting module 16 and moreover can be connected to a tank unit 18. The tank unit 18 preferably constitutes an oil tank with hydraulic oil as the fluid medium. The modular unit as claimed in the invention however can also be used for other fluid media, such as water, special alcohols, gasoline, etc. The tank unit 18 as shown in FIG. 1 is made as a rectangular container, the face-side wall toward the viewer having been omitted in order to illustrate the engagement of the cooling unit 14 with the tank unit 18.

The connecting module 16 with the tank unit 18 connected projects with an intake opening 20 (compare FIGS. 4 and 6) together with the cooling unit 14 into the interior 22 of the tank unit 18, the pump unit 12 being located outside of the tank unit 18. In the embodiment as shown in FIG. 1, the indicated three units 10, 12, 14 running at a right angle to one another are connected to the connecting module 16 and in this way span a type of imaginary Cartesian coordinate system. In an embodiment of the modular unit as claimed in the invention which is not detailed, it would however also be possible to attach the filter unit 10 in the longitudinal axis to the pump unit 12 on the opposite side of the connecting module 16 so that in this respect all three units 10, 12, 14 would form a type of T-shape. Furthermore, the possibility exists of attaching other functional units to the walls 24 of the connecting module housing 26 which have remained free, for example in the form of other filter units, heat exchangers, or the like.

The housing 26 of the connecting module 16 is made angular and has two connecting arms 28, 30 which run at a right angle to one another, the filter unit 10 being connected to the arm 28 and the other second connecting arm 30 forming a connection possibility for the cooling unit 14. Furthermore, the connecting module 16 facing the pump unit 12 has a pump flange 32, and facing the cooling unit 14 between the tank unit 18 and the connecting arm 30 there is a tank flange 34. The tank flange 34 can detachably connect the indicated modular unit to the tank unit. Furthermore, the pump unit 12 on its side facing away from the pump flange 32 has a drive motor 36 for the pump unit 12, preferably in the form of an electric motor. As shown in FIG. 1, the drive motor 36 can be connected to the top of the tank unit 18 by way of a base element 38, in the same manner as the tank flange 34. Furthermore, the connecting module 16 on its side opposite the cooling unit 14 has connection sites 40 for a cooling medium. In order to have a possibility for display of the degree of fouling of the filter element of the filter unit 10, on the upper side of the connecting module 16 seen in FIG. 1 there is a fouling display 42.

With the modular unit as claimed in the invention as shown in FIG. 1, it is possible to remove the fluid medium stored in the tank unit 18 by way of the intake opening 20 which is routed separately to the cooling unit 14 by means of the pump unit 12, to then filter the medium removed in this case by way of the filter unit 10 and to return the medium which has been filtered in this way to the tank unit 18 by way of the cooling unit 14, the cooling unit being preferably a so-called tube bundle cooler. The structure of this cooler is conventional so that it will not be detailed here. The cooled medium is discharged via a discharge opening 44 on the underside of the tube bundle cooler in the form of a cylindrical cooling unit 14. The respective unit 10, 12, 14 except for the tank unit 18 is made in the form of cylindrical connecting parts for the connecting module 16. If the modular unit is to be removed from the tank unit 18, this is easily possible after releasing the screw connection on the tank flange 34, then the base element 38 of the drive motor 36 likewise having to be released. But it is also possible to leave the modular unit on the tank unit 18 and for example to replace a fouled filter element of the filter unit 10 for maintenance purposes by removing or decoupling the housing and/or parts of the housing, such as for example the cover of the filter unit 10, accordingly from the connecting module 16.

In order to illustrate fluid routing between the units 10, 12 14 and within the connecting module 16, the connecting module 16 shown in FIG. 2 is shown in part in a section in different views in the following figures. The connecting module 16 as shown in FIG. 2 in turn shows the housing 26 with the two connecting arms 28, 30. Facing the viewer of FIG. 2, on the side wall of the connecting module 16 is the pump flange 32, and as the lower termination of the arm 30 the tank flange 34 is connected to the connecting module 16. The pump flange 32 has two fluid passage openings, viewed in the direction of looking at FIG. 2 the intake connection 46 being located underneath, and lying overhead in a vertical plane, the pressure connection 48. By way of the pertinent connections 46, 48 fluid circulation is possible by means of the motor pump unit 36, 12. Viewed in the direction of looking at FIG. 2, at the top in the housing 26 there is a connecting opening 50 for the connection sites 40 of the cooling medium and a screw-in opening 52 for the fouling display 42. On the forward face of the housing 26 is the mounting opening 54 for the housing of the filter unit 10.

As shown especially by FIG. 3, in the area of the mounting opening 54 for the filter unit 10 within the housing 26 the pressure connection 48 of the pump unit 12 discharges into the housing 26, in this way the pressure connection 48 being divided into three distributor openings 56 (see in this respect also FIG. 6). This yields an improved, uniform distribution of the fluid flow into the pertinent filter unit 10. Bye way of these distributor openings 56, fouled fluid travels to the filter element of the filter unit 10 and the cleaned fluid travels via the filter element back into a collecting opening 58 (compare FIG. 3) to which the cooling unit 14 is connected to carry fluid. The medium which has been cleaned in this way via the filter unit 10 then travels via the collecting opening 58 into the cooling unit 14 and from there cooled via the discharge opening 44 back into the interior 22 of the tank unit 18. As furthermore follows from the bottom view of the tank flange 34 as shown in FIG. 4, there is a through opening 60 there for accommodating the cooling unit 14, viewed in the direction of looking at FIG. 4 its lower receiving circuit being widened by the intake opening 20, in this respect on the bottom of the tank flange 34 the intake opening 20 discharging into the through opening 60 (compare FIG. 6). As FIG. 4 furthermore shows, the pressure connection 48 conversely ends on the inside wall of the housing 26 of the connecting module 16 and in this way via the distributor openings 56 the fluid flow originating from the pressure connection 48 is delivered directly into the filter unit 10 for a cleaning process.

In the solution as claimed in the invention, the intake opening 20 is located in a plane-parallel termination to the bottom of the tank flange 34. If the modular unit as shown in FIG. 1 is placed on the tank unit 18 from the top, care should be taken that the tank unit 18 is also filled to the full extent with the fluid medium, so that fluid can be removed via the pump unit 12 by means of the tank flange 34 directly on the underside of the container wall of the tank unit 18. But the possibility also exists in an embodiment which is not detailed to lengthen this intake opening 20 to the bottom in the direction of the free end of the cooling unit 14. This however may mean that an additional component in the form of an intake pipe or the like would have to be used. But preferably the modular unit is attached laterally to the tank unit 18, this typical installation situation being implemented when the subject matter as shown in FIG. 1 is pivoted counterclockwise by 90° in the direction of viewing, so that the side designation ⅓ then points to the top. In this case then filling of the tank unit 18 only up to the intake opening 20 of the tank flange 34 would be necessary. Regardless, of course other installation possibilities can be implemented. With the modular unit as claimed in the invention, it is possible to provide a connection to almost any tank units 18 without further piping in the form of fluid lines, in order in this way to perform pumping, filtering and cooling of the stored medium. Furthermore it is possible, in terms of a hydraulic circuit to move the medium by means of the motor pump unit out of the tank unit 18 to elsewhere, for example for operation of a machine (not shown) and to discharge the fluid which may be fouled and which has then been heated in this way from the modular unit cooled and cleaned to the tank unit 19 for recirculation.

1. Modular unit consisting of at least one filter unit (10), one pump unit (12) and one cooling unit (14), which can be connected to each other to carry fluid by way of a connecting module (16) and which can be connected to a tank unit (18), characterized in that the connecting module (16), with the tank unit (18) connected, with an intake opening (20) together with the cooling unit (14) discharges into the interior (22) of the tank unit (18) and that the filter unit (10) and the pump unit (12) are located outside the tank unit (18).

2. The modular unit as claimed in claim 1, wherein at least two, preferably three units (10, 12, 14) running at a right angle to one another are connected to the connecting module (16).

3. The modular unit as claimed in claim 1, wherein the connecting module (16) has an angular housing (26) with two connecting arms (28, 30) running at a right angle to one another, and also has at least one additionally arranged flange part.

4. The modular unit as claimed in claim 3, wherein one flange part is a pump flange (32) and another flange part of the connecting module is a tank flange (34).

5. The modular unit as claimed in claim 1, wherein the connecting module (16) on its side opposite the cooling unit (14) has connecting sites (40) for the cooling medium.

6. The modular unit as claimed in claim 1, wherein for driving the pump unit (12), there is a drive motor (36), in particular an electric motor, which is connected to the pump unit (12) on the side opposite to the connecting module (16).

7. The modular unit as claimed in claim 1, wherein the pump unit (12) with its respective intake connection (46) discharges into the intake opening (20) in the housing (26) of the connecting module (16).

8. The modular unit as claimed in claim 1, wherein the pump unit (12) with its respective pressure connection (48) discharges into the filter housing of the filter unit (10).

9. The modular unit as claimed in claim 1, wherein each respective unit (10,12,14), except for the tank unit (18), is made in the form of cylindrical connecting parts.

10. The modular unit as claimed in claim 1, wherein the intake opening (20) discharges into a through opening (60) in the housing (12) of the connecting module (16) to which the filter unit (10) and the cooling unit (14) can be connected.
